(19) United States
(12) Patent Application Publication
(10) Pub. No.: US 2024/0429984 A1
(43) Pub. Date: Dec. 26, 2024

(54) DATA-DRIVEN WTRU-SPECIFIC MIMO PRE-CODER CODEBOOK DESIGN

(71) Applicant: InterDigital Patent Holdings, Inc., Wilmington, DE (US)

(72) Inventors: Satyanarayana Katla, London (GB); Onur Sahin, London (GB); Yugeswar Deenoo Narayanan Thangaraj, Chalfont, PA (US); Afshin Haghighat, Ile-Bizard (CA); Ghyslain Pelletier, Montreal (CA)

(73) Assignee: InterDigital Patent Holdings, Inc., Wilmington, DE (US)

(21) Appl. No.: 18/698,474

(22) PCT Filed: Oct. 7, 2022
(86) PCT No.: PCT/US2022/046051

§ 371 Date: Apr. 4, 2024

Related U.S. Application Data
(60) Provisional application No. 63/253,682, filed on Oct. 8, 2021.

(51) Int. Cl. H04B 7/06; H04B 7/0456

(52) U.S. Cl. CPC H04B 7/0626; H04B 7/0478

(57) ABSTRACT

Systems, methods, and instrumentalities are disclosed herein for data-driven wireless transmit-receive unit (WTRU)-specific MIMO precoder Codebook, Quality-of-service (e.g., BER) may be improved, for example, using precoders for data transmissions where the precoder is selected from a codebook constructed from observed data. A wireless transmit/receive unit (WTRU) may (e.g., with a base station) construct a codebook based on observed data (e.g., time-varying channel conditions) that include precoders to use for data transmission. The WTRU may determine the codebook, for example, using a precoder prediction model (e.g., using machine learning and/or artificial intelligence).

### CROSS-REFERENCE TO RELATED APPLICATIONS

The application claims the benefit of U.S. Provisional Application 63/253,682, filed Oct. 8, 2021, the contents of which are incorporated by reference in their entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth-generation (4G) long-term evolution (LTE). Wireless communication devices may establish communications with other devices and data networks, e.g., via an access network, such as a radio access network (RAN).

### SUMMARY

Systems, methods, and instrumentalities are disclosed herein for data-driven wireless transmit-receive unit (WTRU)-specific MIMO precoder Codebook. Quality-of-service (e.g., BER) may be improved, for example, using precoders for data transmissions where the precoder is selected from a codebook constructed from observed data. A wireless transmit/receive unit (WTRU) may (e.g., with a base station) construct a codebook based on observed data (e.g., time-varying channel conditions) that include precoders to use for data transmission. The WTRU may determine the codebook, for example, using a precoder prediction model (e.g., using machine learning and/or artificial intelligence).

The WTRU may (e.g., with a base station) use a precoder prediction model to construct a codebook based on observed data. The WTRU may include a processor. The WTRU may determine precoder space selection information. The precoder space selection information may include WTRU-specific precoder action space information. The WTRU may determine precoder space selection information from a base station (e.g., the WTRU may send a reference signal to the base station to establish precoder space selection information). The WTRU may receive first channel state information (e.g., in a channel state information reference signal (CSI-RS)) from the base station. The WTRU may select a first precoder from the WTRU-specific precoder action space information. The WTRU may determine a first reward value for the first precoder (e.g., using a precoder prediction model). The first reward value may be associated with the first CSI-RS. The WTRU may determine whether the precoder prediction model is converged (e.g., a condition is satisfied), for example, based on the first reward value. If the precoder prediction model is converged, the WTRU may indicate to the base station that the model has converged and the precoder and reward value associated with the convergence.

The WTRU may determine that the precoder prediction model is not converged based on the first reward value. The WTRU may select a second precoder from the precoder space selection information. The WTRU may determine a second reward value for the second precoder. The WTRU may continue to select precoders and determine associated reward values to determine model convergence, for example, until the model is converged or a number of iterations has passed.

The WTRU may receive a second CSI-RS from the base station (e.g., after the model is converged). The WTRU may determine a predicted precoder using the second CSI-RS and the precoder prediction model. The WTRU may generate a codebook using the precoder used to determine model convergence and the predicted precoder.

A WTRU may comprise a processor configured to perform a number of actions. A sound reference signal (SRS) may be sent to a network. Precoder space selection information may be received from the network. A data transmission and a channel state information reference signal (CSI-RS) may be received from the network. A reward value may be computed and may be provided together with the CSI-RS to a precoder predictor model as input to obtain a precoder. The obtained precoder may be sent to the network. The precoder predictor model may be determined to be converged. A set of precoders may be requested from the network. The set of precoders may be received from the network and an acknowledgement signal may be sent to the network.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of channel information feedback by a receiver to a transmitter.

FIG. 3 illustrates a description of an example data-driven WTRU-specific codebook design.

FIG. 4 shows an example of a data-driven codebook during training of the deep reinforcement learning (DRL) from the WTRU perspective.

FIG. 5 shows an example of a data-driven codebook during training of the DRL from the next generation nodeB (gNB) perspective.

FIG. 6 shows example signaling procedures during training between the gNB and the WTRU of an example data-driven codebook when AI/ML model (DRL) is employed at the WTRU.

FIG. 7 shows an example of message exchange from the WTRU perspective during real-time data transmission and feedback.

FIG. 8 illustrates an example message exchange between the gNB and the WTRU during real-time data transmission.

FIG. 9 illustrates an example signaling procedures during training between the gNB and the WTRU of a data-driven codebook when AI/ML model (DRL) is employed at the gNB.

FIG. 10 illustrates example signaling procedures during training between the gNB and the WTRU of an example data-driven codebook when AI/ML model (DRL) is mirrored at the gNB and the WTRU.

FIG. 11 illustrates an example flow of determining precoders using a precoder prediction model.

### DETAILED DESCRIPTION

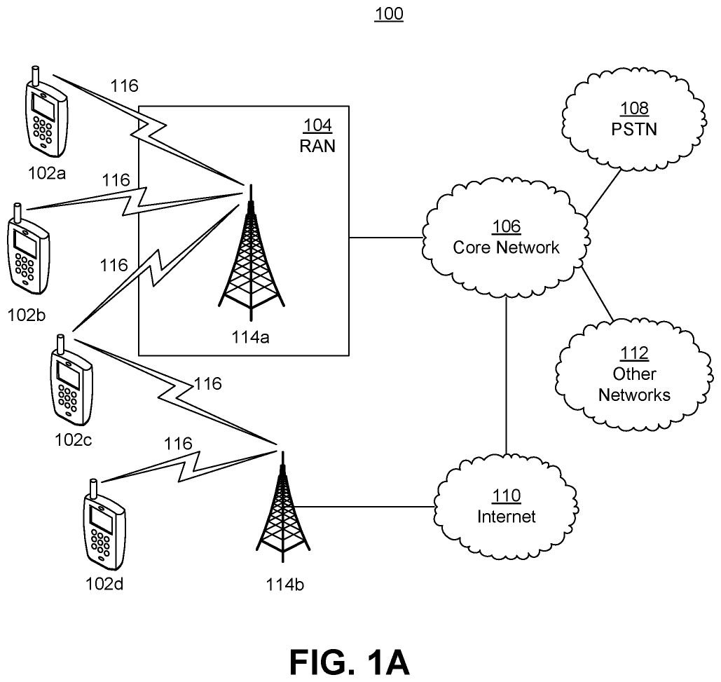

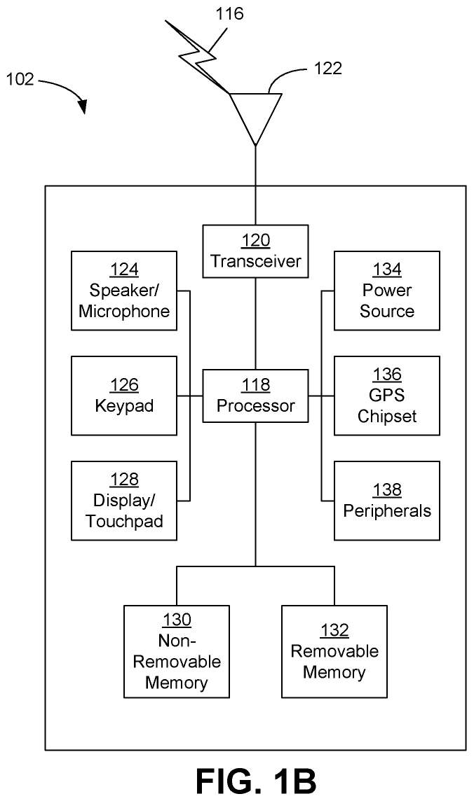

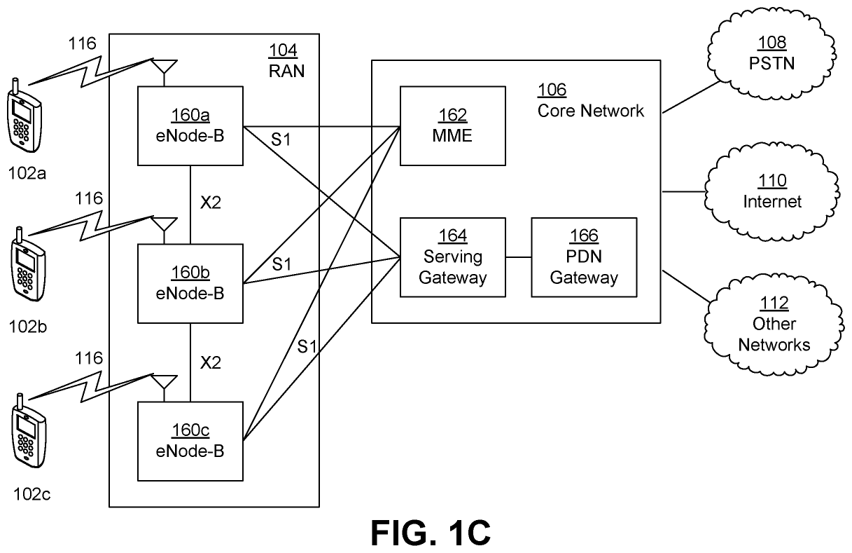

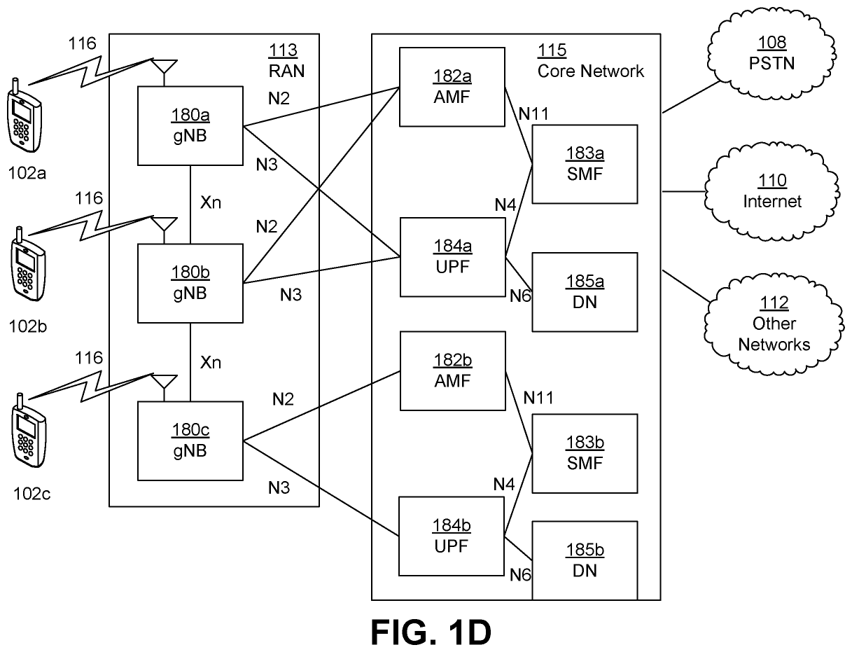

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a -b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are disclosed herein for data-driven wireless transmit-receive unit (WTRU)-specific MIMO precoder Codebook. Quality-of-service (e.g., BER) may be improved, for example, using precoders for data transmissions where the precoder is selected from a codebook constructed from observed data. A wireless transmit/receive unit (WTRU) may (e.g., with a base station) construct a codebook based on observed data (e.g., time-varying channel conditions) that include precoders to use for data transmission. The WTRU may determine the codebook, for example, using a precoder prediction model (e.g., using machine learning and/or artificial intelligence).

The WTRU may (e.g., with a base station) use a precoder prediction model to construct a codebook based on observed data. The WTRU may include a processor. The WTRU may determine precoder space selection information. The precoder space selection information may include WTRU-specific precoder action space information. The WTRU may determine precoder space selection information from a base station (e.g., the WTRU may send a reference signal to the base station to establish precoder space selection information). The WTRU may receive first channel state information (e.g., in a channel state information reference signal (CSI-RS) from the base station. The WTRU may select a first precoder from the WTRU-specific precoder action space information. The WTRU may determine a first reward value for the first precoder (e.g., using a precoder prediction model). The first reward value may be associated with the first CSI-RS. The WTRU may determine whether the precoder prediction model is converged (e.g., a condition is satisfied), for example, based on the first reward value. If the precoder prediction model is converged, the WTRU may indicate to the base station that the model has converged and the precoder and reward value associated with the convergence.

The WTRU may determine that the precoder prediction model is not converged based on the first reward value. The WTRU may select a second precoder from the precoder space selection information. The WTRU may determine a second reward value for the second precoder. The WTRU may continue to select precoders and determine associated reward values to determine model convergence, for example, until the model is converged or a number of iterations has passed.

The WTRU may receive a second CSI-RS from the base station (e.g., after the model is converged). The WTRU may determine a predicted precoder using the second CSI-RS and the precoder prediction model. The WTRU may generate a codebook using the precoder used to determine model convergence and the predicted precoder.

A WTRU may comprise a processor configured to perform a number of actions. A sound reference signal (SRS) may be sent to a network. Precoder space selection information may be received from the network. A data transmission and a channel state information reference signal (CSI-RS) may be received from the network. A reward value may be computed and may be provided together with the CSI-RS to a precoder predictor model as input to obtain a precoder. The obtained precoder may be sent to the network. The precoder predictor model may be determined to be converged. A set of precoders may be requested from the network. The set of precoders may be received from the network and an acknowledgement signal may be sent to the network.

Reference herein to a gNB may refer to an example base station, and the gNB may be substituted with any other suitable base station.

Employing channel adaptive signaling in wireless communication systems may yield improvements (e.g., large improvements) in performance metrics. These adaptive techniques may use channel knowledge at a transmitter. Channel knowledge may not be leveraged directly in frequency division duplexing systems. By a receiver sending feedback (e.g., bits about the channel conditions such as channel quality, rank, etc.), adaptation (e.g., near-optimal adaption) may be allowed. Feeding channel information by the receiver to the transmitter (e.g., as described herein) may be referred to as limited or finite-rate feedback systems. With feedback (e.g., carefully designed feedback), less-than-optimal transmitter channel knowledge systems may achieve near-optimal performance.

A receiver employing feedback may use a low rate data stream (e.g., on the reverse side of a link) to convey information of channel to a transmitter (e.g., on the forward side of the link). For example, downlink carrier frequency channel information may be conveyed by the receiver on an uplink carrier frequency. The downlink carrier frequency information may include channel state information (CSI), a channel quality indicator (CQI), a rank indicator (RI) of the channel, a precoder matrix indicator (PMI), an interference level, etc. The type of information fed back by the receiver may depend on a network (e.g., network requirement(s)). This information may convey some notion of a forward link condition (e.g., channel state, received power, interference level, etc.). The transmitter may use the information to adapt forward link transmission(s). The value of feedback may vary with the system scenario.

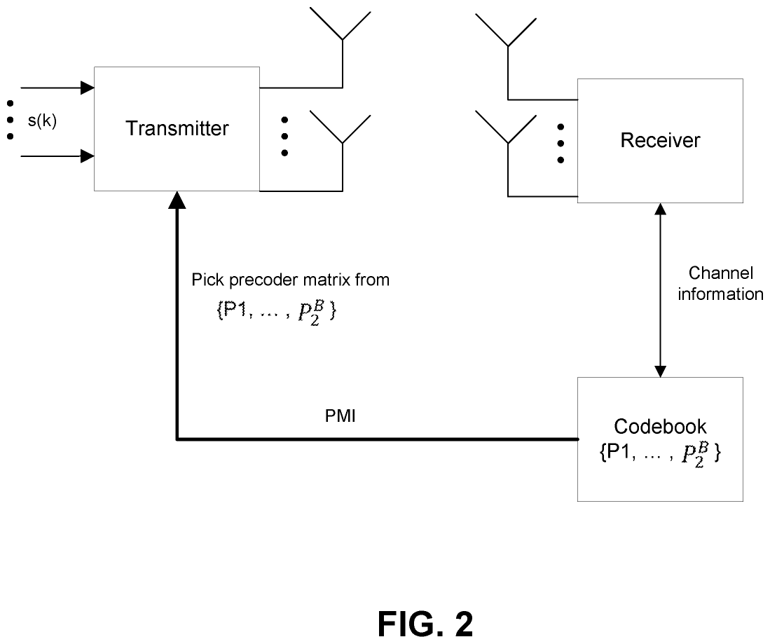

FIG. 2 illustrates an example of channel information feedback by a receiver (e.g., WTRU) to a transmitter (e.g., a base station, such as a gNB) The WTRU may feed back an index of a precoder matrix from a codebook of size 2B, where B may be a number of bits used to convey the index.

The receiver, WTRU, may obtain downlink channel knowledge, e.g., using a reference symbol transmitted by the gNB. The WTRU may estimate the channel and may pick a precoder from a pre-determined codebook, which may be available to the gNB and the WTRU. The codebook may comprise a set of precoders, for example, which may be tailored/designed (e.g., according to an assumed specific channel distribution). The type of precoders may correspond to channel eigen value(s), phase quantization value(s), and/or quantized channel matric(es). This kind of selection of precoder from a predetermined codebook is demonstrated in FIG. 2. In such manner, the receiver may control how a signal may be adapted to the channel.

The number of feedback bits (e.g., the number of feedback bits used to convey the channel information) may depend on a codebook size. In the case of a codebook of size 2\hat{ }B, B bits of a chosen precoder may be sent over the feedback channel. A rate and/or a signal to noise ratio (SNR) may be known as side information to facilitate communication and may be fed back.

The channel state information (e.g., obtained by feedback) may be outdated or may suffer from feedback error(s) (e.g., hardware impairment(s)). Because of these errors, the transmitter may adapt the transmit power and/or data rate, e.g., according to such imperfect channel state and idle time (CSIT) information. The error statistics of the CSIT information may be taken into account in the adaptation, e.g., to effectively exploit the imperfect channel information at the transmitter. It may be difficult (e.g., very difficult) for the transmitter to obtain and/or keep track of the error statistics, e.g., because the error statistics may depend on the channel environment and/or Doppler spectrum. In such cases, ACK/NAK signaling from an upper layer ARQ may be useful (e.g., very useful) to provide a closed-loop adaptation (e.g., a truly closed-loop adaptation).

Using feedback may create overhead on one side of a link to benefit the achievable data rate on the other side. The feedback may be non-negligible. For example, the overhead involved in the feedback (e.g., for a multiuser scenario) may be on the order of several hundreds of bits. This may reduce (e.g., significantly) the throughput of the system.

Precoding/codebook design for MIMO systems may face time-varying channel condition(s).

The selection of the PMI using channel estimate at the WTRU may be inaccurate for one or more of the following reasons. The hardware imperfection(s) arising due to non-linear component(s) may distort the channel estimate. The delay arising in the feedback by the WTRU to the base station (e.g., the gNB) due to channel aging may make the PMI at the gNB outdated. The codebook that is determined based on a fixed probability distribution to represent the wireless channel (e.g., urban, rural, etc.) may result in high quantization error(s). A large overhead in a codebook (e.g., a type II CSI codebook) for multiple user, multiple input, multiple output (MU-MIMO) may make higher rank (e.g., a rank greater than 3) transmission impractical. For example, the feedback for rank-2 may be about 500 bits.

Method(s) for a data-driven WTRU-specific codebook design may improve the quality-of-service (e.g., a bit error ratio (BER). A precoder for data transmission at the base station (e.g., the gNB) may be selected, e.g., from the codebook that is constructed from observed data. The base station and the WTRU may (e.g., be allowed to, be enabled to) identify a (e.g., near-optimal) codeword (e.g., a precoder) that adapts to the time-varying channel condition(s).

A data-driven WTRU-specific codebook design may be implemented.

A data-driven WTRU-specific codebook design for single-user MIMO systems may be implemented, e.g., by using the channel estimate at the WTRU. In such design, the functional mapping between the channel estimate and the precoder selection may be designed using data-driven approach(es), e.g., machine learning, deep reinforcement learning, etc. This approach (e.g., method) may determine (e.g., this approach/method may be used by the WTRU to determine) the precoder that adapts to the CSI observed at the base station (e.g., the gNB) during data transmission, e.g., in real time. The WTRU may feed back the precoder matrix index from the WTRU-specific codebook. The WTRU-specific codebook may be designed based on the channel estimates, for example, observed over a period of time. The WTRU-specific codebook may be obtained by training over real-time data. Precoders pertaining to the time-varying channel observed at the WTRU may be designed (e.g., initially designed). The precoders may be quantized (e.g., subsequently quantized) to derive the WTRU-specific codebook. The codebook may be WTRU-specific, e.g., because the codebook is designed based on the channel estimate observed at that specific WTRU. The gNB may select the precoder for data transmission from the same codebook, e.g., using the PMI fed back by the WTRU. The gNB and/or the WTRU may update the WTRU-specific codebook using the observation (e.g., the data based on the new observation), e.g., depending on the BER. This method may provide better performance in terms of BER. Such better performance may be due to that the codebook is designed from the observed data samples, rather than the simplistic assumption of a tractable probability distribution.

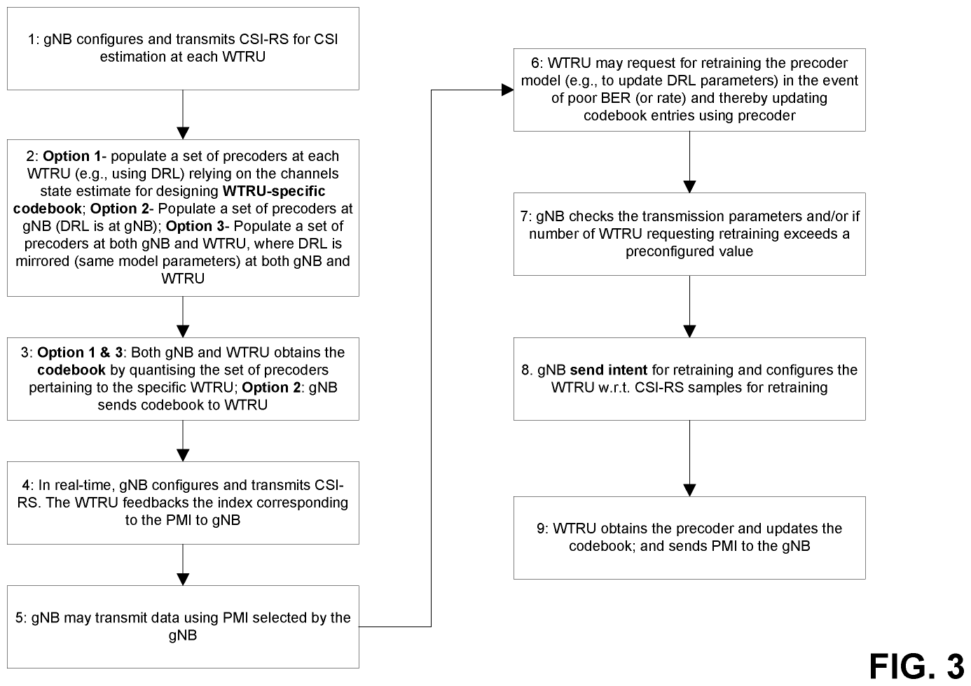

FIG. 3 illustrates an example data-driven WTRU-specific codebook design, where one or more illustrated actions may be performed. At 301, the gNB may configure a WTRU with parameter(s) (e.g., the training iterations/convergence time) and may transmit CSI-RS for channel estimation (H) at the WTRU.

At 302, the WTRU may select the downlink (DL) precoder (e.g., for the gNB) for the next transmission opportunity (TxOP). The WTRU may select the DL precoder from the WTRU-specific data-driven codebook, e.g., using the estimated channel H. The data-driven codebook design (e.g., the training aspect) is described herein. The codebook may be constructed from a set of precoder matrices, for example, which may be designed by data-driven method(s) (e.g., machine learning (ML) that is based on the channel state observation at the WTRU).

In an example scenario (e.g., scenario 1), a training stage may be commenced (e.g., in the initial phase), for example, prior to the codebook construction. The WTRU may observe the channel estimate, H (e.g., which may represent a state). The WTRU (e.g., based on observing the channel estimate, H) may select a precoder, P (e.g., which may represent an action from a continuous action space, for example, selecting a precoder from a set of possible precoders). The WTRU may feed back the precoder to the gNB. The WTRU may use the precoder in the next transmission opportunity (TxOP). Desired metric(s) (e.g., a rate/BER) may be optimized.

In examples, the training may be employed (e.g., offline) using data that may be obtained by a simulation (e.g., that is based on the knowledge of channel statistics). Model parameter(s) (e.g., for a deep reinforcement learning (DRL) model) for obtaining a precoder may be trained, e.g., using this data.

In examples, the initial parameter(s) of the model may be employed, e.g., using the offline training that is based on simulated data. The initial parameter(s) may be updated, e.g., using online training that is based on real-time data. This approach may ensure a fast convergence of the model and/or better performance.

In examples, the precoder prediction model may be constructed using DRL. The training samples (e.g., in a precoder prediction model constructed using DRL) may include the channel estimates H (e.g., which may represent a state), the precoder P (e.g., which may represent an action), and/or the reward (e.g., a rate/BER).

The WTRU may conclude that the model (e.g., a DRL model) is trained, e.g., if the model parameter(s) (e.g. DRL parameter(s)), such as the reward (e.g. the BER), have converged. A continuous action space may be used for selecting the initial random precoder. A continuous action space may be partitioned into a set of small continuous action spaces, e.g., to reduce the convergence time and/or iterations of the training model (e.g., the DRL model). These action spaces may be shared with gNB and WTRU, e.g., offline (e.g., pre-configured and/or stored on the gNB and the WTRU). The gNB may send (e.g., in DCI) an indication to the WTRU indicating (e.g., configure the WTRU using a DCI with) an index of the precoder action space, e.g., during the model training. The WTRU may select a precoder (e.g., random precoder) initially from the precoder action space (e.g., for data transmission depending on the CSI estimate at the WTRU), e.g., during the model training. This initial selection of a random precoder for the model (DRL) training may be WTRU-specific. e.g., because the CSI for each WTRU may be different and/or may be a different precoder action space. In examples, the gNB may send (e.g., in DCI) an indication to the WTRU indicating (e.g., configure the WTRU using DCI with) an index of the precoder action space based on one or more of the following. The gNB may obtain the CSI based on an SRS received from the WTRU in the uplink. The gNB may identify the precoder action space for that specific WTRU based on the CSI.

In examples, the initial precoder may be chosen from a pre-defined codebook (e.g., which may be an existing network-based (e.g., NR based) codebook), e.g., to reduce the convergence time.

The WTRU may (e.g., if the precoder predictor model (e.g., the DRL model) is trained) obtain a set of precoders Sp={P1, P2, . . . , PN} over diverse channel realizations {H1, H1, . . . , HN} (e.g., in a next phase), for example, using the trained precoder model (DRL) parameter(s)). The set of precoders may be fed back to the gNB, e.g., after channel realizations (e.g., after each channel realization). In examples, the (e.g., existing) CSI-RS signals may be used to populate precoders and/or may be used at the training stage (e.g., which may implicitly reduce overhead).

The WTRU may employ a quantization scheme to obtain a codebook (e.g., in a final phase), e.g., if a set of precoders is obtained.

In an example scenario (e.g., scenario 2), during training, the gNB may indicate in DCI (e.g., configure using DCI) a number of bits (e.g., B number of bits), e.g., to be used in precoder feedback by the WTRU in the UL. The WTRU may feed back a precoder that is quantized to B number of bits to the gNB. The gNB may transmit data and/or CSI-RS, e.g., using the quantized precoder sent by the WTRU. The WTRU may compute a reward using the quantized precoder, e.g., based on the received signal from the gNB.

In an example scenario (e.g., scenario 3), the training using DRL (e.g., an Al/ML engine) may be employed at the gNB. The precoder selection during training of DRL may be employed by the gNB. The gNB may send data and/or CSI-RS, e.g., using the selected precoder. The WTRU may compute the reward (e.g., a BER), e.g., in response to reception of the data and CSI-RS. The WTRU may feed back the reward and/or compressed CSI to the gNB, e.g., using uplink control information (UCI) or a PUSCH transmission. This process may be continued, e.g., until the convergence of the reward (e.g., the BER) or for a (e.g., preconfigured) number of iterations. In the case that DRL is employed by the gNB and a precoder is selected by the gNB during DRL training, the following scenarios may occur. In case 1, the WTRU may be transparent to the precoder selected by the gNB, e.g., because the gNB transmits precoded DMRS(s). In this case, the WTRU may compute the reward (e.g., the BER) using the DMRS(s) and may feed back to the gNB the reward and compressed effective CSI. The effective CSI may be Heff=HP, for example, where H is the channel, P is the precoder, and Heff is the product of H and P. In case 2, the WTRU may be cognizant of the precoder selected by the gNB, e.g., because the gNB sends CSI-RS for estimating the precoder selected by gNB in addition to DMRS. In this case, the WTRU may feed back to the gNB the reward and compressed CSI.

In an example scenario (e.g., scenario 4), the DRL training employed by the gNB may be mirrored at the WTRU. In this case, the gNB and the WTRU employ DRL. An initial random seed and/or model parameter(s) for DRL for precoder selection may be indicated (e.g., configured) by the gNB. For example, the configuration information (e.g., indicating the initial random seed and/or model parameter(s)) may be sent to the WTRU using DCI. The gNB may transmit data and CSI-RS to the WTRU. The WTRU may compute the reward and may feed back the reward and compressed CSI to the gNB. In this case, the WTRU may identify (e.g., accurately identify) the precoder selected at the gNB, for example, without precoder estimation, e.g., because the DRL parameter(s) and initial random seed are shared by gNB and the WTRU.

At 303, the gNB and the WTRU may obtain the codebook by quantizing the set of precoders (e.g., in scenario 1 or scenario 2, as described herein).

In examples (e.g., scenario 3 as described herein), the gNB may obtain the codebook by quantizing the set of precoders (e.g., in case 1 as described herein). The gNB may feed back the entire codebook to the WTRU (e.g., using DCI) or may upload to a network (e.g., a cloud network) where the WTRU may download the codebook. In case 2 (e.g., as described here), the gNB and the WTRU may obtain the codebook by quantizing the set of precoders, e.g., since WTRU is also cognizant of the precoder(s).

In examples (e.g., scenario 4 as described here), the gNB and the WTRU may obtain the codebook by quantizing the set of precoders.

At 304 (e.g., inference may be performed), one or more of the following procedures may be performed (e.g., during real-time data transmission, e.g., if training is complete), e.g., if the codebook is determined at the gNB and the WTRU. The gNB may configure CSI-RS and may transmit the CSI-RS to the WTRU, e.g., if (e.g., when) the gNB wants to (e.g., indicates to) carry out CSI measurement(s). The WTRU may estimate the channel and may feed back the PMI from the codebook (e.g., in the first TxOP). The WTRU may feed back a differential PMI (e.g., only a differential PMI), for example, if the report configuration is set to PMI by the gNB (e.g., in the subsequent TxOP(s)). The differential PMI may be a difference between the previous PMI and the current selected PMI.

At 305, the gNB may transmit data using the PMI suggested by the WTRU (e.g., the PMI fed back by the WTRU).

At 306, the WTRU may request precoder codebook retraining from the gNB (e.g., in order to update the WTRU-gNB codebook entries), for example, if the BER does not meet a threshold for a certain number of times. In an example, the gNB may request retraining, e.g., if MU-MIMO is considered (e.g., which may be considered in an update or at a later stage).

At 307, the gNB may check and may determine that the network transmission parameter(s) or the number of WTRUs in the network requesting for retraining satisfy the preconfigured value (e.g., that is necessary) for retraining. This preconfigured value may be a BER, a network sum rate, or the number of WTRUs requesting for retraining.

At 308, the gNB may send an intent to the WTRU, e.g., whether the gNB will configure the WTRU for retraining in a next TxOP or the gNB continues to transmit data.

At 309, the WTRU may (e.g., if the intent for retraining is received from the gNB) update its precoder prediction model parameter(s) (e.g., ML parameter(s)), e.g., to obtain the precoders. For example, the WTRU may update its precoder prediction model parameter(s) using the training samples. The WTRU may (e.g., if precoders are obtained at the WTRU) send a differential precoder (e.g., only a differential precoder) to the gNB, e.g., to reduce overhead. For example, if the previously selected PMI is 6 and the currently selected PMI is 5, the difference of the two PMIs (e.g., which is 6−5=1 or 5−6=−1) may be transmitted. The gNB and the WTRU may update codebook entries.

If intent for continued data transmission is received, the WTRU may revert to the conventional (e.g., classical) PMI for data transmission. For example, the conventional PMI may be an existing codebook (e.g., as in 5G NR) based PMI feedback.

The WTRU may revert to the existing codebook (e.g., as in 5G NR) based PMI feedback, e.g., if online training/retraining for updating the model parameter(s) is not converged (e.g., after a pre-configured number of iterations or within a preconfigured time duration).

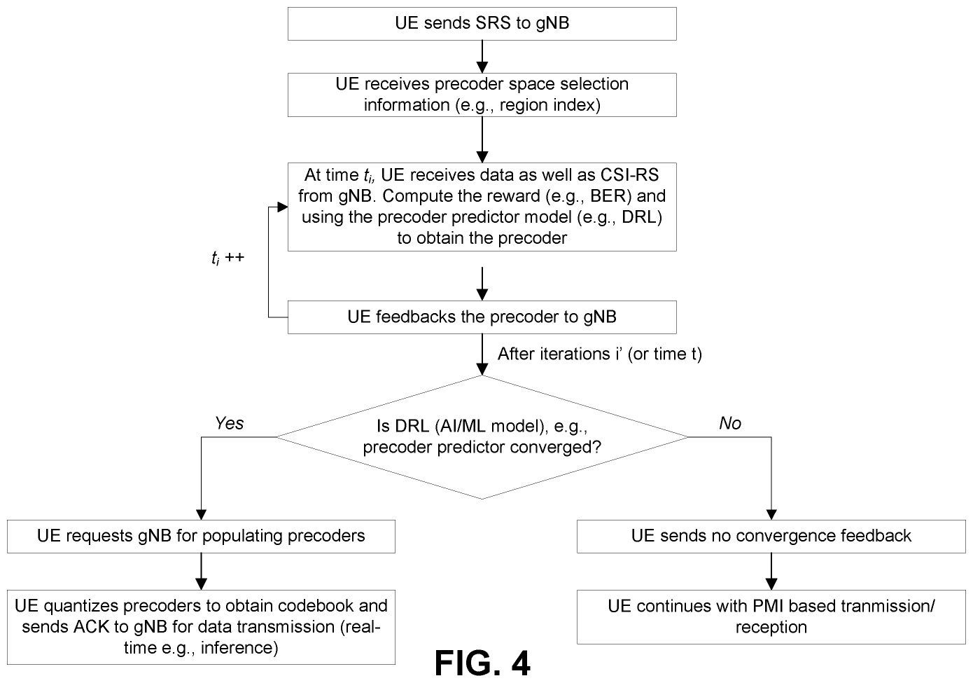

FIG. 4 shows an example of a data-driven codebook during training of the DRL from the WTRU perspective, where one or more illustrated actions may be performed. The criterion for convergence of DRL (AI/ML model) may be if the reward (e.g. the BER) has attained a maximum value with respect to DRL and does not change with more iteration(s).

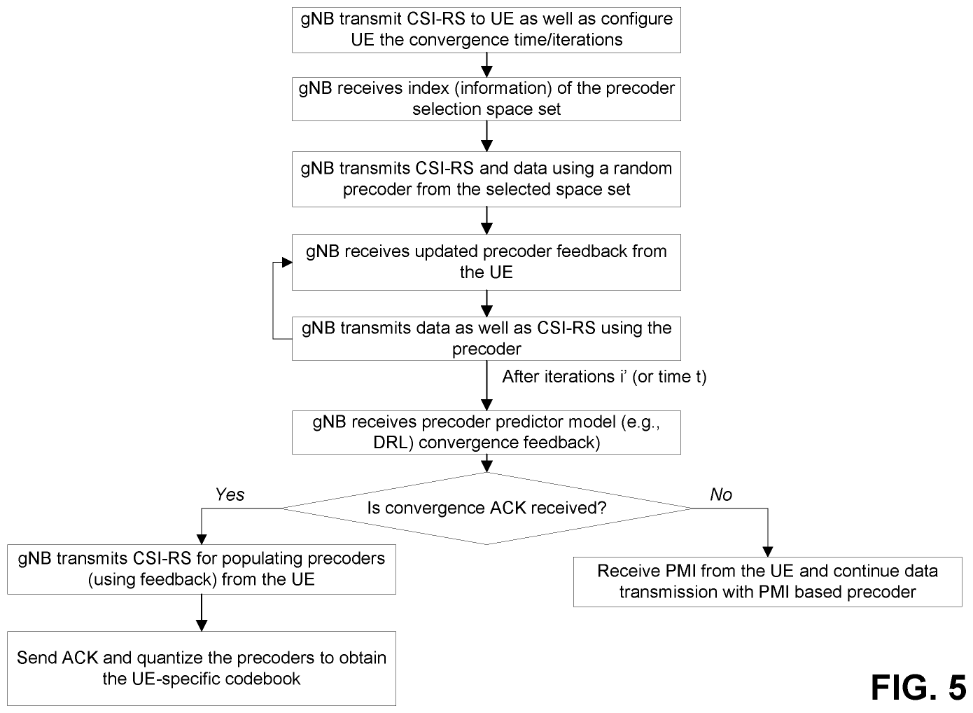

FIG. 5 shows an example of a data-driven codebook during training of the DRL from the gNB perspective, where one or more illustrated actions may be performed.

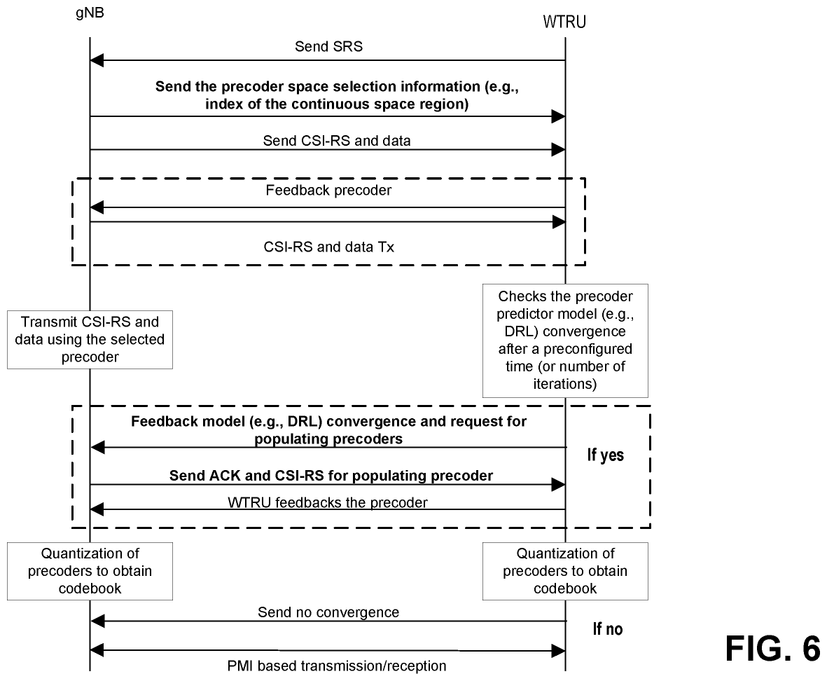

FIG. 6 shows example signaling procedures during training between the gNB and the WTRU of an example data-driven codebook, when AI/ML model (DRL) is employed at the WTRU. One or more illustrated actions may be performed. As shown in FIG. 6, the WTRU may send an SRS to a base station (e.g., to establish WTRU-specific precoder action space information with the base station). As shown in FIG. 6, the WTRU may receive precoder space selection information (e.g., determine precoder space selection information). The precoder space selection information may include an index of the continuous space region. The precoder space selection information may include WTRU-specific precoder action space information. As shown in FIG. 6, the WTRU may receive CSI-RS and data (e.g., first CSI-RS), for example, from a base station (e.g., gNB). As shown in FIG. 6, the WTRU may feedback precoder(s) to the base station (e.g., select a first precoder from the WTRU-specific precoder action space information, determine a reward value for the first precoder using a precoder prediction model). As shown in FIG. 6, the WTRU may check the precoder predictor model (e.g., DRL model) convergence (e.g., based on the reward value). As shown in FIG. 6, the WTRU may determine that the precoder predictor model converged (e.g., a condition is satisfied, for example, based on a reward value). As shown in FIG. 6, the WTRU may indicate to the base station the convergence of the precoder predictor model (e.g., with the reward value and the precoder associated with the reward value).

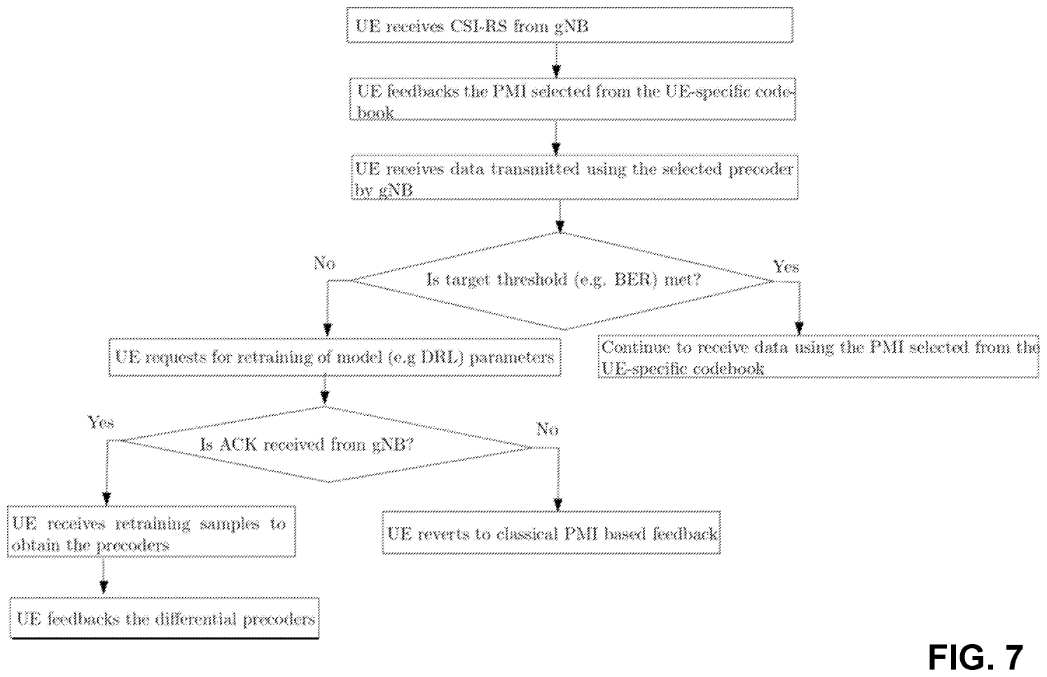

FIG. 7 shows an example of message exchange from the WTRU perspective during real-time data transmission and feedback, where one or more illustrated actions may be performed.

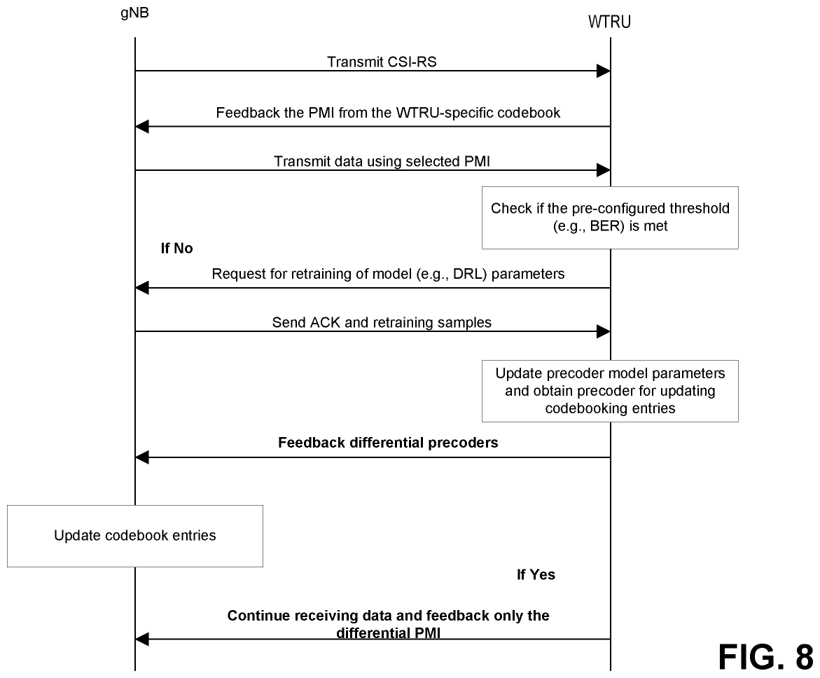

FIG. 8 illustrates an example message exchange between the gNB and the WTRU during real-time data transmission, where one or more illustrated actions may be performed. The differential PMI may be the difference of the PMI in the previous TxOP and the PMI in the current TxOP. For example, if the previously selected PMI is 6 and the currently selected PMI is 5, then difference of the two PMIs (e.g., which is 6−5=1 or 5−6=−1 may be transmitted

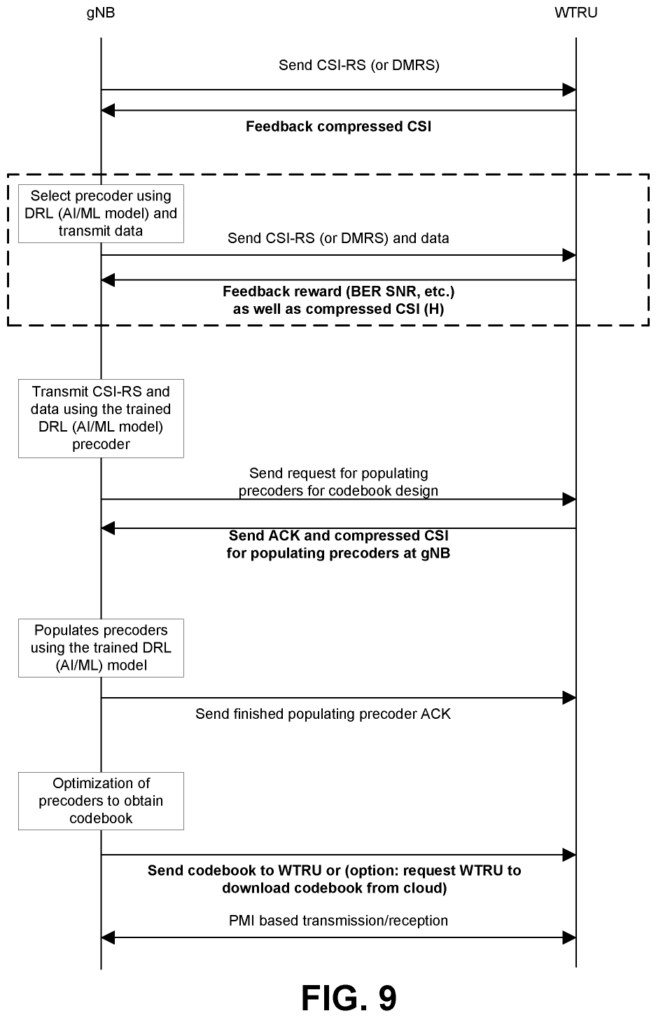

FIG. 9 illustrates an example signaling procedures during training between the gNB and the WTRU of a data-driven codebook, when AI/ML model (DRL) is employed at the gNB. One or more illustrated actions may be performed.

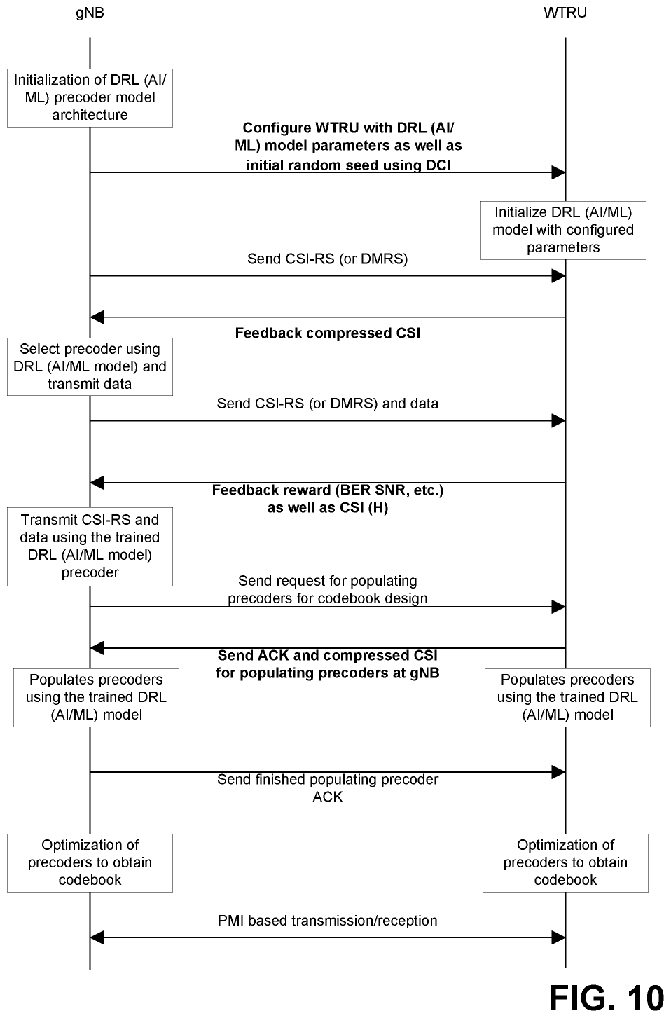

FIG. 10 illustrates example signaling procedures during training between the gNB and the WTRU of an example data-driven codebook, when AI/ML model (DRL) is mirrored at the gNB and the WTRU. One or more illustrated actions may be performed.

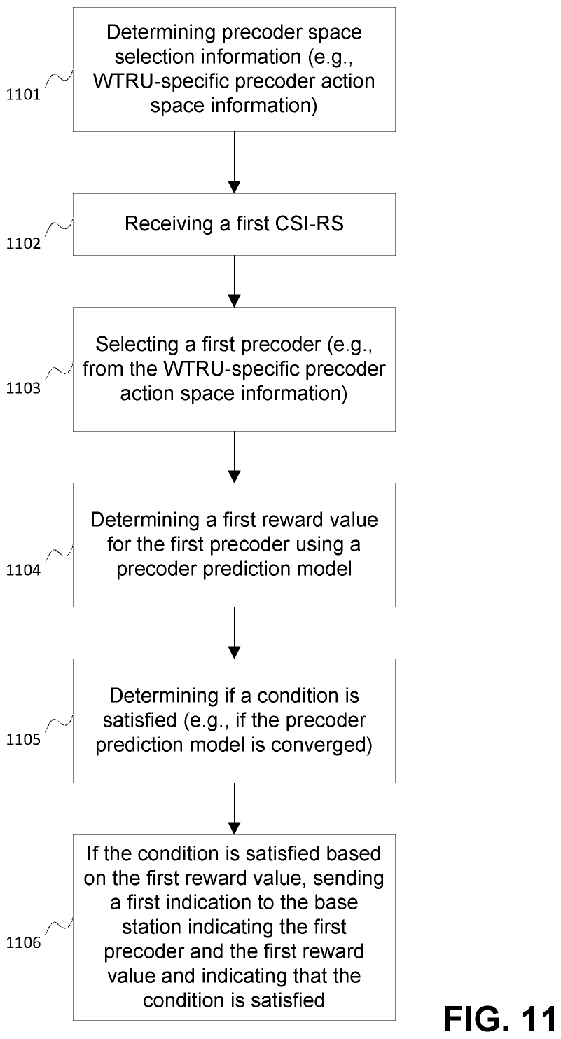

FIG. 11 illustrates an example flow of determining precoders using a precoder prediction model as described herein, where one or more of the illustrated features may be performed. As shown in FIG. 11, at 1101, precoder space selection information may be determined. The precoder space selection information may include WTRU-specific precoder action space information. As shown at 1102 in FIG. 11, a first CSI-RS may be received (e.g., from a base station). As shown at 1103 in FIG. 11, a first precoder may be selected. The first precoder may be selected from the WTRU-specific precoder action space information. As shown at 1104 in FIG. 11, a first reward value may be determined for the first precoder. The first reward value may be determined, for example, using a precoder prediction model. Whether a condition is satisfied may be determined. For example, the condition may be whether the precoder prediction model is converged. Whether the condition is satisfied may be determined, for example, based on the first reward value (e.g., whether the precoder prediction model is converged may be determined based on the first reward value). An indication may be sent to the base station (e.g., if the condition is satisfied based on the first reward value). The indication may indicate the first precoder and the first reward value (e.g., if the condition is satisfied based on the first reward value). The indication may indicate that the condition is satisfied.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read-only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer-executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object-oriented programming language to communicate with a computer system. However, the program(s) can be implemented in assembly or machine language, if desired. In any case, the language may be a compiled or interpreted language and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing the preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-14. (canceled)

15. A wireless transmit/receive unit (WTRU) comprising,
a processor configured to:
determine precoder space selection information, wherein the precoder space selection information comprises WTRU-specific precoder action space information;
receive a first channel state information reference signal (CSI-RS) from a base station;
select a first precoder from the WTRU-specific precoder action space information;
determine a first reward value for the first precoder using a precoder prediction model, wherein the first reward value is associated with the first CSI-RS;
determine whether a condition is satisfied based on the first reward value; and
based on the determination of whether the condition is satisfied based on the first reward value, send an indication to the base station, wherein the indication indicates precoder information and reward value information.

16. The WTRU of claim 15, wherein the determination of whether the condition is satisfied based on the first reward value comprises a determination of whether the precoder prediction model has converged based on the first reward value, wherein the determination that that the condition is satisfied based on the first reward value is further based on a determination that the precoder prediction model has converged based on the first reward value.

17. The WTRU of claim 15, wherein the precoder prediction model is a machine learning model.

18. The WTRU of claim 15, wherein the processor is further configured to:
send a sounding reference signal (SRS) to the base station, wherein the SRS is associated with establishing the WTRU-specific precoder action space information with the base station.

19. The WTRU of claim 15, wherein the first reward value is associated with at least one of a data rate or a bit error rate.

20. The WTRU of claim 15, wherein the processor is further configured to:
determine that the condition is not satisfied based on the first reward value;
based on the determination that the condition is not satisfied based on the first reward value, select a second precoder from the WTRU-specific precoder action space information;
determine a second reward value for the second precoder using the precoder prediction model, wherein the second reward value is associated with the first CSI-RS; and
determine that the condition is satisfied based on the second reward value, wherein based on the determination that the condition is satisfied based on the second reward value, the precoder information indicates the second precoder, the reward value information indicates the second reward value, and the indication indicates that the condition is satisfied.

21. The WTRU of claim 15, wherein based on a determination that the condition is satisfied based on the first reward value, the precoder information indicates the first precoder, the reward value information indicates the first reward value, and the indication further indicates that the condition is satisfied.

22. The WTRU of claim 15, wherein the processor is further configured to:
receive a second CSI-RS from the base station;
determine a predicted precoder using the second CSI-RS and the precoder prediction model; and
generate a codebook based on the first precoder and the predicted precoder.

23. A method, the method comprising,
determining precoder space selection information, wherein the precoder space selection information comprises WTRU-specific precoder action space information;
receiving a first channel state information reference signal (CSI-RS) from a base station;
selecting a first precoder from the WTRU-specific precoder action space information;
determining a first reward value for the first precoder using a precoder prediction model, wherein the first reward value is associated with the first CSI-RS;
determining whether a condition is satisfied based on the first reward value; and
based on a determination that the condition is satisfied based on the first reward value, sending an indication to the base station, wherein the indication indicates precoder information and reward value information.

24. The method of claim 23, wherein the determination of whether the condition is satisfied based on the first reward value comprises a determination of whether the precoder prediction model has converged based on the first reward value, wherein the determination that that the condition is satisfied based on the first reward value is further based on a determination that the precoder prediction model has converged based on the first reward value.

25. The method of claim 23, wherein the precoder prediction model is a machine learning model.

26. The method of claim 23, wherein the method further comprises:
sending a sounding reference signal (SRS) to the base station, wherein the SRS is associated with establishing the WTRU-specific precoder action space information with the base station.

27. The method of claim 23, wherein the first reward value is associated with at least one of a data rate or a bit error rate.

28. The method of claim 23, wherein the method further comprises:
determining that the condition is not satisfied based on the first reward value;
based on the determination that the condition is not satisfied based on the first reward value, selecting a second precoder from the WTRU-specific precoder action space information;
determining a second reward value for the second precoder using the precoder prediction model, wherein the second reward value is associated with the first CSI-RS; and
determining that the condition is satisfied based on the second reward value, wherein based on the determination that the condition is satisfied based on the second reward value, the precoder information indicates the second precoder, the reward value information indicates the second reward value, and the indication indicates that the condition is satisfied.

29. The method of claim 23, wherein based on a determination that the condition is satisfied based on the first reward value, the precoder information indicates the first precoder, the reward value information indicates the first reward value, and the indication further indicates that the condition is satisfied.

30. The method of claim 23, wherein the method further comprises:
receiving a second CSI-RS from the base station;
determining a predicted precoder using the second CSI-RS and the precoder prediction model; and
generating a codebook based on the first precoder and the predicted precoder.
